(19) United States
(12) Patent Application Publication
(10) Pub. No.: US 2014/0025962 A1
(43) Pub. Date: Jan. 23, 2014

(54) INFORMATION PROCESSING APPARATUS, INFORMATION PROCESSING METHOD, INFORMATION PROCESSING SYSTEM, AND PROGRAM

(71) Applicant: Sony Corporation, Tokyo (JP)

(72) Inventors: Toshihiko Suzuki, Tokyo (JP); Kazumasa Miyazaki, Tokyo (JP); Takuya Kosugi, Tokyo (JP)

(21) Appl. No.: 13/942,130

(22) Filed: Jul. 15, 2013

(30) Foreign Application Priority Data
Jul. 23, 2012 (JP) 2012-162490

(51) Int. Cl. G06F 21/60

(52) U.S. Cl. CPC G06F 21/602
USPC 713/193

(57) ABSTRACT

There is provided an information processing apparatus including a communication unit configured to acquire encrypted information that is encrypted with a local code from another information processing apparatus, and a control unit configured to decrypt the encrypted information to generate content and store the content into a removable medium.

### BACKGROUND

The present disclosure relates to an information processing apparatus, an information processing method, an information processing system, and a program.

According to a technique disclosed in Japanese Patent Laid-Open No. 2012-34153, encrypted information that has been encrypted in accordance with DLNA/DTCP-IP standards is received through a network. Then the encrypted information is decrypted, and the decrypted information is again encrypted in accordance with iVDR standards and stored into a removable medium (removable medium). Japanese Patent Laid-Open 2009-71786 discloses an AV server apparatus that connects communication devices of distinct communication formats with each other. This server apparatus converts a communication format of content received from one of the communication devices into a communication format suitable for the other communication device and then outputs the content to the other communication device.

### SUMMARY

However, neither Japanese Patent Laid-Open No. 2012-34153 nor Japanese Patent Laid-Open 2009-71786 discusses local encryption. Meanwhile, content that is locally encrypted is device-bound to a device (e.g., a television receiver) that has carried out the local encryption and thus is not shared by another device. Accordingly, there has been a demand for a technique that allows information (content) that is locally encrypted to be shared among a plurality of devices.

According to an embodiment of the present disclosure, there is provided an information processing apparatus including a communication unit configured to acquire encrypted information that is encrypted with a local code from another information processing apparatus, and a control unit configured to decrypt the encrypted information to generate content and store the content into a removable medium.

According to an embodiment of the present disclosure, there is provided an information processing apparatus including a control unit configured to acquire content from a removable medium and encrypt the content with a local code to generate encrypted information, and a communication unit configured to output the encrypted information to another information processing apparatus.

According to an embodiment of the present disclosure, there is provided an information processing method including acquiring encrypted information that is encrypted with a local code from another information processing apparatus, and decrypting the encrypted information to generate content and storing the content into a removable medium.

According to an embodiment of the present disclosure, there is provided an information processing method including acquiring content from a removable medium and encrypting the content with a local code to generate encrypted information, and outputting the encrypted information to another information processing apparatus.

According to an embodiment of the present disclosure, there is provided a program to cause a computer to realize a communication function of acquiring encrypted information that is encrypted with a local code from another information processing apparatus, and a control function of decrypting the encrypted information to generate content and storing the content into a removable medium.

According to an embodiment of the present disclosure, there is provided a program to cause a computer to realize a control function of acquiring content from a removable medium and encrypting the content with a local code to generate encrypted information, and a communication function of outputting the encrypted information to another information processing apparatus.

According to an embodiment of the present disclosure, there is provided an information processing system including a first information processing apparatus; and a second information processing apparatus including a communication unit configured to acquire encrypted information that is encrypted with a local code from the first information processing apparatus, and a control unit configured to decrypt the encrypted information to generate content and store the content into a removable medium.

According to an embodiment of the present disclosure, there is provided an information processing system including a first information processing apparatus; and a second information processing apparatus including a control unit configured to acquire content from a removable medium and encrypt the content with a local code to generate encrypted information, and a communication unit configured to output the encrypted information to the first information processing apparatus.

According to an embodiment of the present disclosure, an information processing apparatus acquires encrypted information that has been locally encrypted from another information processing apparatus and decrypts the encrypted information to generate content. Then, the information processing apparatus stores the content into a removable medium.

As described above, according to an embodiment of the present disclosure, the content that has been generated by decrypting the encrypted information that has been locally encrypted can be stored into the removable medium, and thus the content that is locally encrypted can be shared among a plurality of devices.

### BRIEF DESCRIPTION OF THE DRAWINGS

FIG. 1 is an external view illustrating a schematic of an information processing system according to an embodiment of the present disclosure;

FIG. 2 is a block diagram illustrating a hardware configuration of the information processing system;

FIG. 3 is a block diagram illustrating a configuration of a television receiver (another information processing apparatus, a first information processing apparatus);

FIG. 4 is a block diagram illustrating a configuration of a connection module (information processing apparatus, a second information processing apparatus) and a removable medium;

FIG. 5 is a descriptive diagram illustrating an example of an internal data structure of a ring buffer;

FIG. 6 is a descriptive diagram illustrating a configuration of a title database;

FIG. 7 is a descriptive diagram illustrating a configuration of a conversion database;

FIG. 8 is a descriptive diagram illustrating an internal data structure of a non-volatile memory;

FIG. 9 is a flowchart illustrating procedures in processing of the information processing system;

FIG. 10 is a flowchart illustrating procedures in processing of the information processing system;

FIG. 11 is a flowchart illustrating procedures in processing of the information processing system;

FIG. 12 is a flowchart illustrating procedures in processing of the information processing system; and

FIG. 13 is a flowchart illustrating procedures in processing of the information processing system.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the descriptions will be given in the following order.

1. Review of Related Arts

2. Overview of Information Processing System

3. Configuration of Information Processing System
3-1. Hardware Configuration
3-2. Configuration of Television Receiver
3-3. Configuration of Connection Module
3-4. Configuration of Removable Medium

4. Procedures in Processing of Information Processing System
4-1. Connection Module Recognition Processing
4-2. Connection Module Registration Processing
4-3. Recording Start Processing
4-4. Playback Start Processing

### <1. Review of Related Arts>

The present inventors have reviewed related arts to the present embodiment to come to an information processing system 10 of the present embodiment. Thus, the review carried out by the present inventors will be described first.

A technique for connecting a non-removable medium (e.g., an external hard disk drive) to a television receiver has been proposed. According to this technique, the television receiver receives broadcast content and locally encrypts the received broadcast content to generate encrypted information. The television receiver then stores the encrypted information into the non-removable medium. Local encryption is encryption that is specific to each device, and encrypted information that has been locally encrypted is decrypted only by a device that has carried out the local encryption. Accordingly, the encrypted information that is stored in the external hard disk drive is device-bound to the television receiver. In other words, this television receiver is compliant with the device-bind.

Accordingly, according to the technique described above, the encrypted information is device-bound to the television receiver, and thus the encrypted information may not be shared by another device.

Meanwhile, according to the technique disclosed in Japanese Patent Laid-Open No. 2012-34153, encrypted information that has been encrypted in accordance with DLNA/DTCP-IP standards is received through a network. Then, the encrypted information is decrypted, and the decrypted information is again encrypted in accordance with iVDR standards and stored into a removable medium. That is, according to the technique disclosed in Japanese Patent Laid-Open No. 2012-34153, content is converted in accordance with DRM (Digital Rights Management) standards (in this example, iVDR standards) of the removable medium and can be stored into the removable medium. Through this, the technique disclosed in Japanese Patent Laid-Open No. 2012-34153 allows a variety of content to be media-bound (i.e., to be stored into a removable medium). In this way, the removable medium protects the content through various DRM standards. In other words, the removable medium provides the content with DRM information that is set through various DRM standards (i.e., information to protect copyright, for example, access control information), to thereby protect the content.

Thus, according to this technique, a television receiver that is capable of reading out the content in the removable medium (i.e., a television receiver that is capable of DRM processing compatible with the removable medium) can share the content in the removable medium.

However, Japanese Patent Laid-Open No. 2012-34153 does not discuss local encryption. Furthermore, as described above, the technique disclosed in Japanese Patent Laid-Open No. 2012-34153 only assumes a television receiver that is compliant with the media-bind. That is, with the technique disclosed in Japanese Patent Laid-Open No. 2012-34153, a television receiver that is not compliant with the media-bind (e.g., a television receiver that is compliant with only the device-bind) may not be able to read out the content in the removable medium.

It should be noted that as a method to allow a television receiver that is not compliant with the media-bind to read out the content in the removable medium, a method in which a DRM processing function that is compatible with the removable medium is added to the television receiver can be considered. That is, this method allows the television receiver to become compliant with the media-bind.

However, with this method, there has been a demand for an existing system in the television receiver (e.g., hardware, software, and so on) to be modified. In addition, in a case where the television receiver is to be made compliant with a plurality of types of media-binds (i.e., removable media), there has been a demand for a distinct DRM processing function for each removable medium to be added to the television receiver. In this case, the cost increases in accordance with the number of DRM processing functions. Accordingly, this method incurs high costs in allowing a television receiver that is not compliant with the media-bind to read out the content in the removable medium.

Meanwhile, Japanese Patent Laid-Open 2009-71786 discloses an AV server apparatus that connects communication devices of distinct communication formats with each other. This server apparatus converts a communication format of content received from one of the communication devices into a communication format of the other communication device and then outputs the content to the other communication device. However, Japanese Patent Laid-Open No. 2009-71786 does not discuss local encryption, either.

The present inventors have diligently reviewed the techniques described above to come to the information processing system 10 of the present embodiments. According to the information processing system 10, a television receiver 20 can store content into a removable medium and also read (play back) content in the removable medium irrespective of the removable medium. That is, according to the information processing system 10, content that is locally encrypted can be shared among a plurality of devices.

### <2. Overview of Information Processing System>

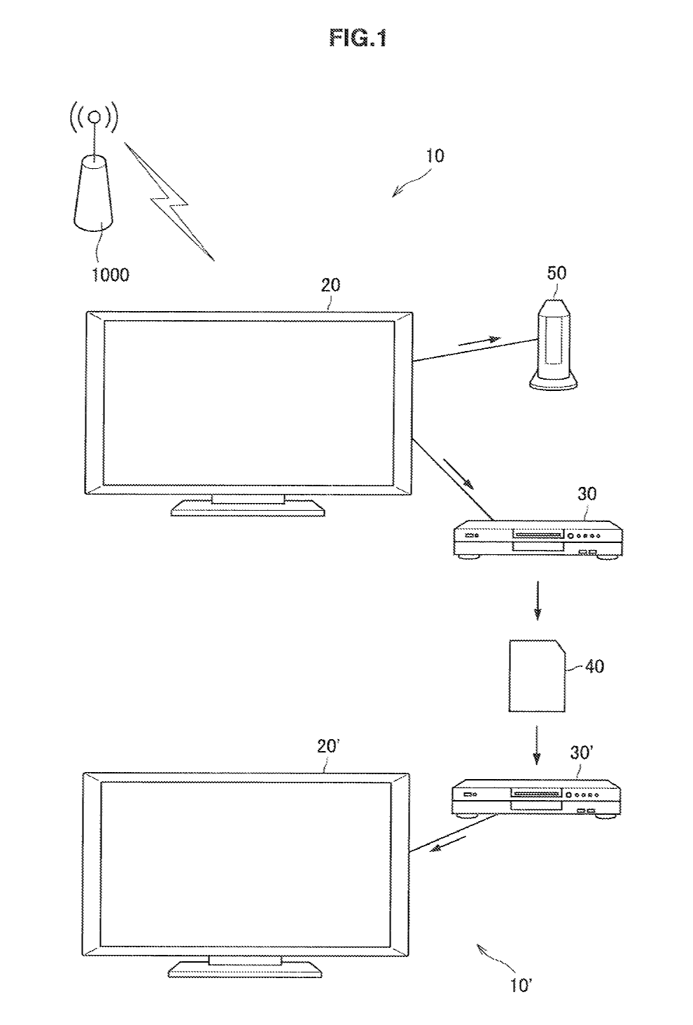

An overview of the information processing system 10 will now be described with reference to FIG. 1. The information processing system 10 primarily includes a television receiver 20, a connection module 30, and a removable medium 40. Note that although the television receiver 20 is connected to an external hard disk drive 50 in this example, the external hard disk drive 50 is optional.

The television receiver 20 receives broadcast content from a broadcasting tower 1000. The television receiver 20 locally encrypts the received broadcast content to generate encrypted information. The television receiver 20 stores the encrypted information into the external hard disk drive 50. Accordingly, the encrypted information that is stored in the external hard disk drive 50 is device-bound to the television receiver 20.

Meanwhile, the television receiver 20 can output the encrypted information to the connection module 30. The connection module 30 is associated with (i.e., device-bound to) the television receiver 20. That is, the connection module 30 shares a local code with the television receiver 20. Thus, the connection module 30 decrypts the encrypted information to generate the broadcast content. The connection module 30 converts the broadcast content into a DRM format that is compatible with the removable medium 40 and stores the broadcast content into the removable medium 40. Accordingly, it is not necessary for the television receiver 20 to carry out processing that takes the removable medium 40 into consideration. Furthermore, it is not necessary for the television receiver 20 to be compliant with the media-bind. That is, it is not necessary for the television receiver 20 to be associated with the removable medium 40.

In this way, the connection module 30 carries out the conversion from the device-bind to the media-bind. That is, the connection module 30 decrypts the device-bound encrypted information to generate the broadcast content. Further, the connection module 30 converts the broadcast content into a DRM format that is compatible with the removable medium 40. Then, the connection module 30 stores the broadcast content into the removable medium 40. That is, the connection module 30 media-binds the broadcast content to the removable medium 40. Accordingly, the television receiver 20 can substantially comply with the media-bind as long as the television receiver 20 is compliant with the device-bind.

Thereafter, a user connects the removable medium 40 to a connection module 30′ that constitutes another information processing system 10′. Here, similarly to the information processing system 10, the information processing system 10′ includes a television receiver 20′ and the connection module 30′. The connection module 30′ is associated with the television receiver 20′. That is, the connection module 30′ shares a local code with the television receiver 20′.

The connection module 30′ releases the DRM information of the broadcast content (recorded content) that is stored in the removable medium 40 and also locally encrypts the broadcast content. Through this, the connection module 30′ generates encrypted information. The connection module 30′ outputs the encrypted information to the television receiver 20′. The television receiver 20′ decrypts the encrypted information to generate the broadcast content and carries out various processing (displaying the broadcast content and so on). Accordingly, it is not necessary for the television receiver 20′ to carry out processing that takes the removable medium 40 into consideration, either. Furthermore, it is not necessary for the television receiver 20′ to be compliant with the media-bind. That is, it is not necessary for the television receiver 20′ to be associated with the removable medium 40. Accordingly, with the present embodiment, the influence on existing systems (software and hardware) in the television receivers 20 and 20′ can be reduced as much as possible. Further, even in a case where the television receivers 20 and 20′ deal with a new removable medium in the future, the present embodiment makes it possible to take care of the situation only on the connection module side. Note that although the reception and the display of the broadcast content are carried out separately in the information processing systems 10 and 10′, respectively, in the example described above, the information processing system 10 alone may carry out both.

### <3. Configuration of Information Processing System>

### (3-1. Hardware Configuration)

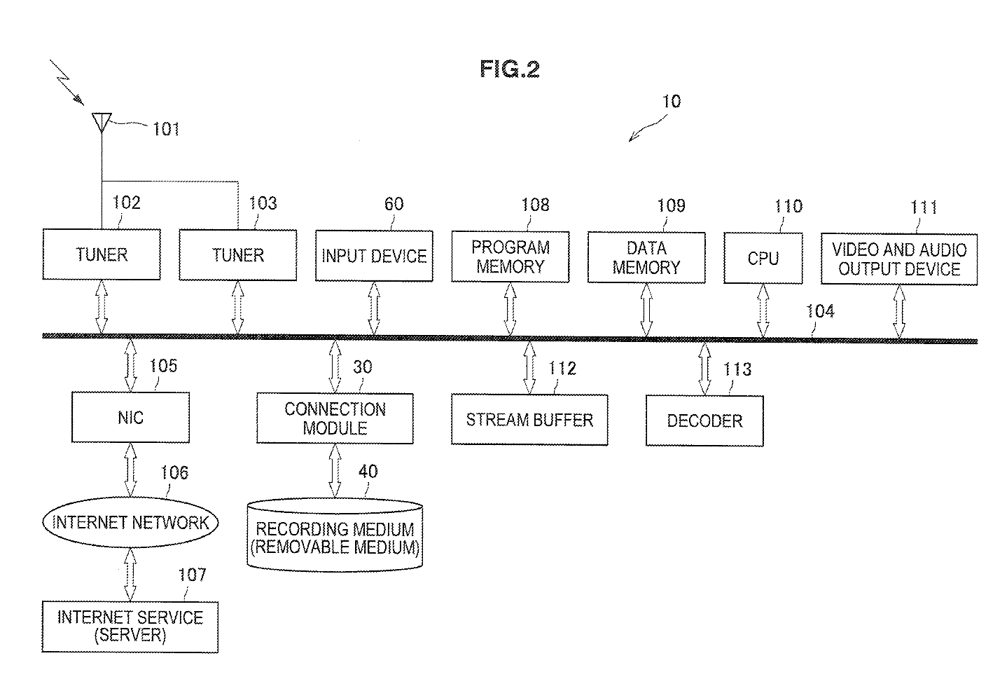

An example of the hardware configuration of the information processing system 10 will now be described with reference to FIG. 2. The information processing system 10 includes, as its hardware configuration, an antenna 101, tuners 102 and 103, a bus 104, an NIC (Network Interface Card) 105, and an input device 60. The information processing system 10 further includes, as its hardware configuration, the connection module 30, the removable medium 40, a program memory 108, and a data memory 109. The information processing system 10 further includes, as its hardware configuration, a CPU 110, a video and audio output device 111, a stream buffer 112, and a decoder 113. The antenna 101, the tuners 102 and 103, the bus 104, the NIC 105, the program memory 108, the data memory 109, the CPU 110, the video and audio output device 111, the stream buffer 112, and the decoder 113 constitute the television receiver 20.

The antenna 101 and the tuners 102 and 103 receive broadcast content from the broadcasting tower 1000 as stream data and temporarily store the stream data into the stream buffer 112. Note that the tuners 102 and 103 can each select a desired piece of data among a plurality of pieces of stream data received through the antenna 101. That is, the information processing system 10 can simultaneously select two pieces of stream data. Through this, the information processing system 10 can record a program other than a program a user is viewing. Note that in a case where only a program which a user is viewing is to be recorded, only a single tuner may be provided. The tuners 102 and 103 may be designated respectively as live viewing only and as program recording only, or may be used in parallel.

The bus 104 connects the hardware configurations to one another. Further, the information processing system 10 is connected to a server 107 through the NIC 105 and an internet network 106. The server 107 can transmit communication content to the information processing system 10 as stream data. This communication content is temporarily stored in the stream buffer 112 as well. Note that the server 107 can also store content transmitted from the information processing system 10.

The connection module 30 allows the removable medium 40 to be attached to and detached from the information processing system 10 and also carries out the processing described above. That is, the connection module 30 stores the content that is stored in the stream buffer 112 into the removable medium 40. The connection module 30 may be embedded in the television receiver 20 or may be allowed to be attached to and detached from the television receiver 20. The connection module 30 may be in any form as long as the connection module 30 allows the removable medium 40 to be attached to and detached from the connection module 30 and may, for example, be a portable phone and the like. The connection module 30 includes separate computation processing functions in order to carry out encryption, decryption, and the like of the content.

The removable medium 40 may be in any form as long as the removable medium 40 can be attached to and detached from the connection module 30 and, for example, includes an HDD, a silicon memory, and so on. The removable medium 40 may be configured of a single device or may be configured of a plurality of separate devices.

The input device 60 is a device that can be operated by a user in order to turn ON/OFF a system power supply, to switch channels, and so on, and examples of the input device 60 include a keyboard, a remote control, a switch, a mouse, and so on.

The program memory 108 stores a program that allows the CPU 110 to realize functions according to the present embodiment. The data memory 109 stores temporary data for computation. The CPU 110 loads the program stored in the program memory 108 to execute the program. The video and audio output device 111 is a so-called display panel, which displays various video images and outputs various audios. The stream buffer 112 is a ring buffer and temporarily stores the content. The stream buffer 112 is divided into an information recording buffer and an information playback buffer. An example of the internal data structure of the information recording buffer is illustrated in FIG. 5. In this example, a plurality of “stream” directories is present under a “rec” directory, and a stream file is stored in each of the “stream” directories. In the example illustrated in FIG. 5, the name of the stream file is “rec.m2ts.” The stream file is configured of a single piece or a plurality of pieces of stream data. Meanwhile, the internal data structure of the information playback buffer is similar to that of the information recording buffer. However, file names are different. For example, in the information playback buffer, the name of the stream file is “play.m2ts. The decoder 113 sequentially decodes the content within the stream buffer 112 and displays the content in the video and audio output device 111. These hardware configurations make is possible to realize each functional block described hereinafter.

### (3-2. Configuration of Television Receiver)

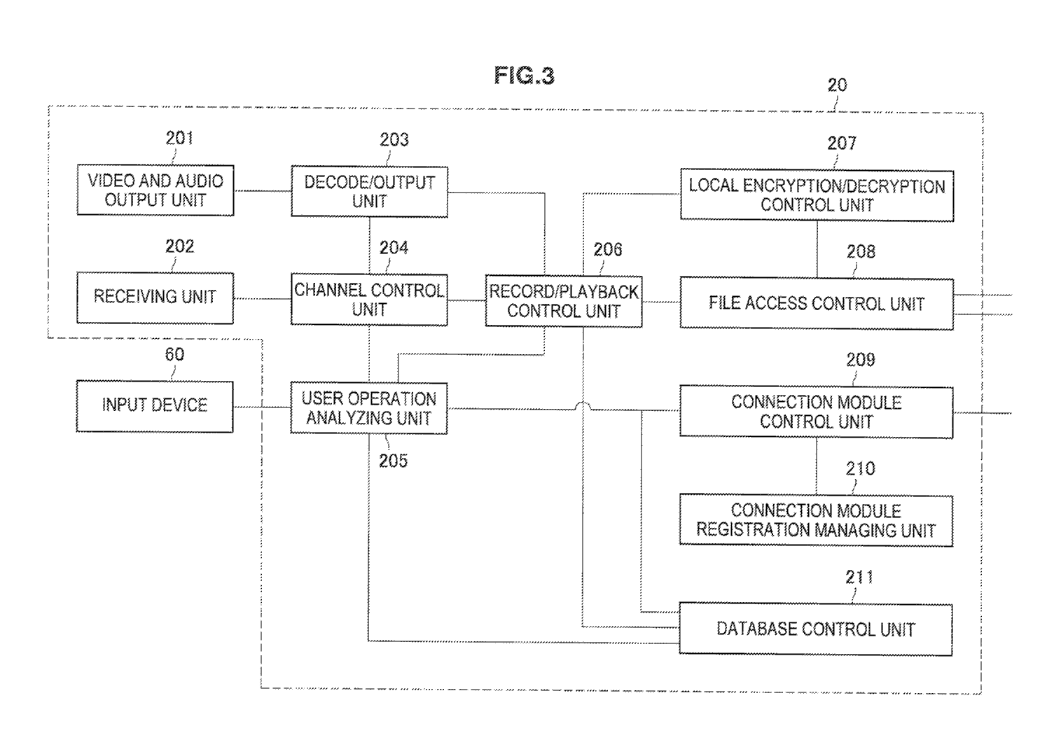

The configuration of the television receiver 20 will now be described with reference to FIG. 3. The television receiver 20 includes a video and audio output unit 201, a receiving unit 202, a decode/output unit 203, a channel control unit 204, a user operation analyzing unit 205, and a record/playback control unit 206. The television receiver 20 further includes a local encryption/decryption control unit 207, a file access control unit 208, a connection module control unit 209, a connection module registration managing unit 210, and a database control unit 211.

The video and audio output unit 201 corresponds to the video and audio output device 111 described above. The receiving unit 202 corresponds to the antenna 101 and the tuners 102 and 103 described above.

The decode/output unit 203 decodes stream data received through the receiving unit 202 and outputs the stream data to the video and audio output unit 201 and the record/playback control unit 206. When there is a request for a channel setting (user operation), the channel control unit 204 configures the settings for the receiving unit 202. The channel control unit 204 also manages current channel information and makes a request for the content to the record/playback control unit 206.

The user operation analyzing unit 205 analyzes each user operation (e.g., a channel operation, the start of recording a program, a selection and playback operation of recorded content and so on through a remote control) that is inputted through the input device 60. Then, the user operation analyzing unit 205 outputs an analysis result to the channel control unit 204 or the record/playback control unit 206.

The record/playback control unit 206 carries out various processing based on the analysis result provided from the user operation analyzing unit 205. For example, the record/playback control unit 206 acquires a host side title list (a list of host side title IDs (host side identification information)) from the database control unit 211 and makes a file operation request to the file access control unit 208. Here, as a host side file operation request, a request to open or close a stream file in which content is stored or the like can be cited. In addition, the record/playback control unit 206 outputs stream data for the content to the local encryption/decryption control unit 207 and acquires stream data for the content from the local encryption/decryption control unit 207.

The local encryption/decryption control unit 207 carries out local encryption/decryption processing on each stream data. The file access control unit 208 provides various instructions to the connection module 30 side based on the file operation request. Further, the file access control unit 208 transmits and receives content (stream data) to and from the connection module 30.

The connection module control unit 209 inquires of the connection module 30 as to the database and requests for the host side title list. The connection module registration managing unit 210 holds a registration managing list to manage registration information on the connection module 30. The registration managing list is configured of registration information that is uniquely set for each connection module. For example, the registration managing list records “abcde,” “fghij,” and “klmno” as registration information pieces on connection modules A, B, and C, respectively. The database control unit 211 acquires information that is associated with the requested content from the database. Here, the database may be present in or out of the television receiver 20, but a requesting functional block does not pay attention to the location of the database. That is, the database control unit 211 acquires information requested by each functional block from the database.

### (3-3. Configuration of Connection Module)

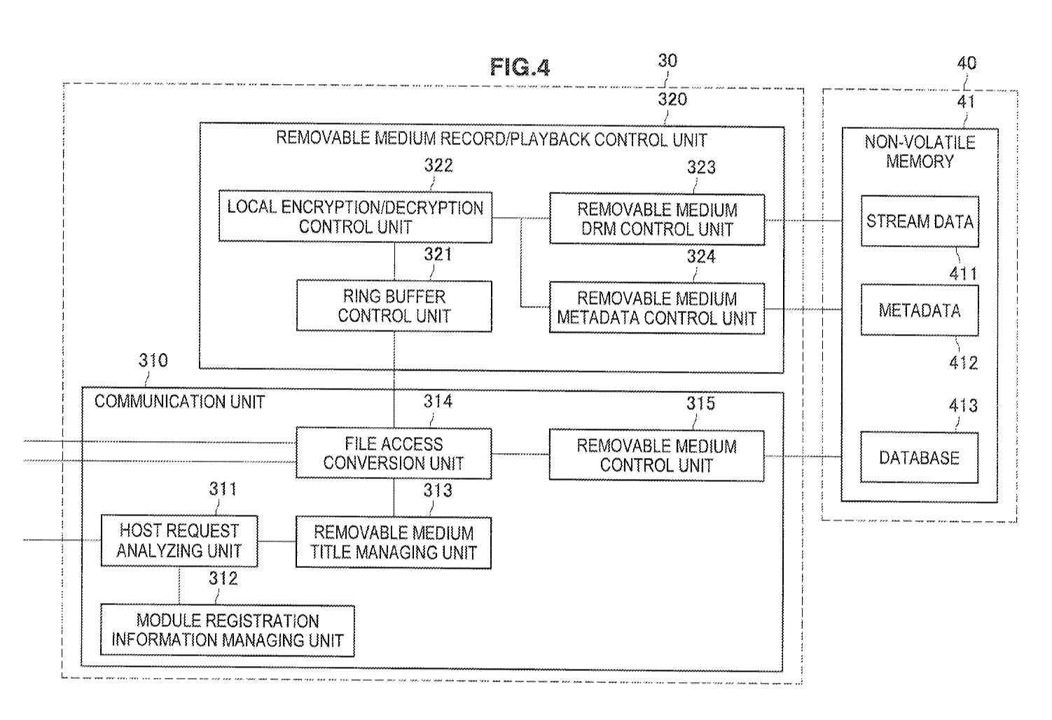

The configuration of the connection module 30 will now be described with reference to FIG. 4. The connection module 30 includes a communication unit 310 and a removable medium record/playback control unit (control unit) 320. The communication unit 310 includes a host request analyzing unit 311, a module registration information managing unit 312, a removable medium title managing unit 313, a file access conversion unit 314, and a removable medium control unit 315. The host request analyzing unit 311 serves as a window for a request other than processing pertaining to a stream file. For example, the host request analyzing unit 311 accepts a request for a host side title list from the television receiver 20, a request for database processing such as new title registration, a request for registration release of a connection module and carries out processing in accordance with each request.

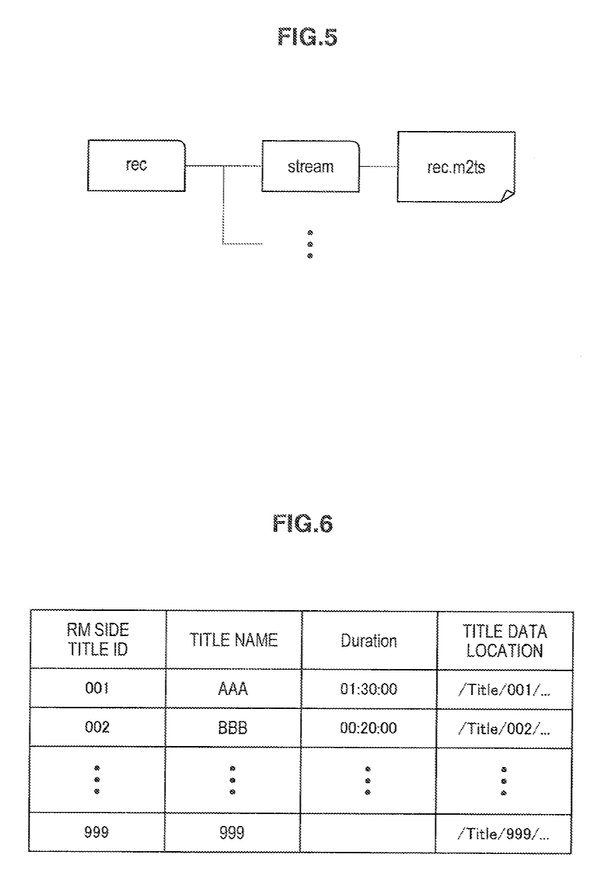

The module registration information managing unit 312 manages registration information which the television receiver 20 outputs when the connection module 30 is registered in the television receiver 20 (i.e., identification information of the television receiver 20). The removable medium title managing unit 313 manages a title database 413 that is recorded in the removable medium 40. An example of the title database 413 is illustrated in FIG. 6. The title database 413 records an RM (removable medium) side title ID, a title name, a playback time (duration), and a title data location in association with one another. The title data location indicates a location at which stream data 411 of the content and metadata 412 of the content are stored, that is, an address thereof.

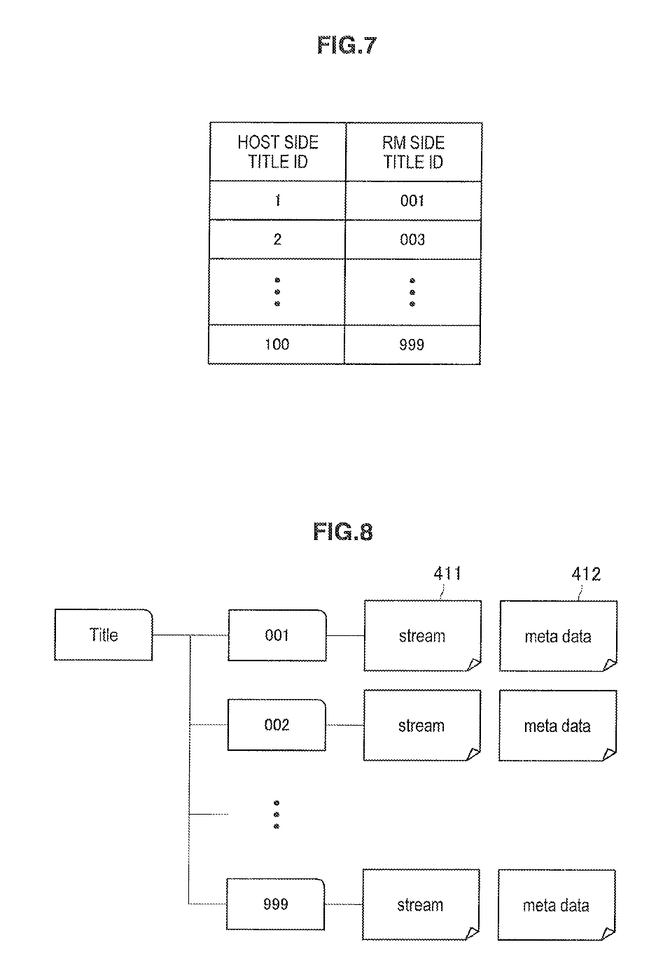

In addition, the removable medium title managing unit 313 generates a conversion database that indicates a correspondence relationship between an RM side title ID and a host side title ID and carries out a mutual conversion between the RM side title ID and the host side title ID based on the conversion database. Here, a host side title ID is obtained by converting an RM side title ID into a format that is compatible with the television receiver 20. An example of the conversion database is illustrated in FIG. 7. In this example, the RM side title IDs are not in the serially numbered order, but the host side title IDs are in the serially numbered order. According to this example, the removable medium title managing unit 313 can convert the RM side title IDs into a serially numbered format which the television receiver 20 can easily deal with. Of course, a modification to the format is not limited to this example. For example, a conversion into various formats is also carried out through the conversion database.

The removable medium record/playback control unit 320 includes a ring buffer control unit 321, a local encryption/decryption control unit 322, a removable medium DRM control unit 323, and a removable medium metadata control unit 324. Roughly speaking, the removable medium record/playback control unit 320 carries out a mutual conversion from a local code into DRM information on the removable medium 40.

The ring buffer control unit 321 annularly manages and controls the stream buffer 112 of a fixed length. Through this, even if a region in the stream buffer 112 is limited, the television receiver 20 side can sequentially read and write the stream data irrespective of the internal processing of the connection module 30.

The local encryption/decryption control unit 322 carries out local encryption and decryption of stream data and metadata.

Here, the local encryption/decryption control unit 322 shares a local code with the television receiver 20. Thus, a method with which the connection module 30 and the television receiver 20 share a local code (more specifically, a key to be used in local encryption and decryption) will be described.

As a method for sharing a key, the following two methods can be considered, for example. Of course, the method for sharing a key is not limited thereto. A first method is applied to a case where the connection module 30 is externally mounted to the television receiver 20. In this case, a user can freely remove the connection module 30 from the television receiver 20 and can also attach the connection module 30 to another television receiver 20 of the same model.

In the first method, the television receiver 20 side and the connection module 30 side generate identical encryption keys (symmetric encryption) when the connection module 30 is registered in the television receiver 20. Specifically, the Diffie-Hellman key exchange method can, for example, be used.

According to this method, the connection module 30 and the television receiver 20 share a common prime number and a common random number, and a common key is generated using the prime number and the random number. In addition, a method in which registration information which the television receiver 20 and the connection module 30 share in order to register the connection module 30 is used can also be considered. For example, suppose the connection module A is connected to and registered in the television receiver 20 and the registration information on the connection module A is “abcde.” In this case, on the television receiver 20 side, the connection module registration managing unit 210 holds the registration information “abcde.” Meanwhile, on the connection module A side, the module registration information managing unit 312 holds the registration information “abcde” of the connection module A itself. Accordingly, the television receiver 20 and the connection module A share the registration information “abcde.”

Then, an algorithm for “uniquely” generating an encryption key from this registration information is set in advance, and the algorithm is held by the television receiver 20 and the connection module A. For example, an example of this algorithm includes an algorithm for carrying out symmetrical encryption such as AES and DES using a certain fixed key with the registration information being regarded as a plain text. Then, the television receiver 20 and the connection module A can each generate an identical symmetric key based on this algorithm and the registration information.

In addition, a method in which a public key encryption algorithm (for example, RSA) is used can also be considered. According to this method, a side that carries out decryption processing generates a key pair (a public key and a private key) and transfers the public key to a side that carries out encryption processing. For example, in a case where broadcast content is to be stored in the removable medium 40 (i.e., the broadcast content is recorded), the connection module 30 generates a key pair and transmits a public key to the television receiver 20. The television receiver 20 then locally encrypts the stream data based on the public key provided by the connection module 30. Then, upon receiving the encrypted stream data, the connection module 30 side decrypts the locally encrypted stream data, that is, the encrypted information using a private key.

A second method is applied to a case where the connection module 30 is embedded in the television receiver 20. In this case, a user may not be able to remove the connection module 30 from the television receiver 20 and attach the connection module 30 to another television receiver 20′. Of course, the connection module 30 may be removable. In such a case, the first method is suitably applied.

According to the second method, removing the connection module 30 is not expected. Accordingly, an encryption key that is specific to a given model is first prepared at the time of manufacture of the television receiver 20, and the encryption key is written into a non-volatile region (for example, the program memory 108) of the host. Subsequently, an encryption key that is identical to the encryption key written into the host is written into a non-volatile region of the connection module 30, which is embedded in the television receiver 20. In this case, the regions into which the keys have been written is desirably managed as secure region to which a user may not be able to access. Through this, with the second method as well, the connection module 30 and the television receiver 20 can share the identical key.

The removable medium DRM control unit 323 converts the stream data provided by the local encryption/decryption control unit 322 in accordance with the DRM standards of the removable medium 40 and stores the converted stream data 411 into the removable medium 40. For example, the removable medium DRM control unit 323 adds DRM information that corresponds to the removable medium 40 to the stream data provided by the local encryption/decryption control unit 322. In addition, the removable medium DRM control unit 323 acquires the stream data 411 from the removable medium 40 and releases the DRM information of the stream data 411. Then, the removable medium DRM control unit 323 outputs the stream data of which the DRM information is released to the local encryption/decryption control unit 322.

The removable medium metadata control unit 324 extracts metadata (title name, playback time, and so on) from the decrypted stream data and subjects the metadata to processing similar to that of the removable medium DRM control unit 323.

### (3-4. Configuration of Removable Medium)

The configuration of the removable medium 40 will now be described. The removable medium 40 includes a non-volatile memory 41 that holds the stream data 411, the metadata 412, and the title database 413. The connection module 30 accesses various pieces of information on the removable medium 40 through the removable medium control unit 315, the removable medium DRM control unit 323, and the removable medium metadata control unit 324. An example of the internal data structure of the removable medium 40 is illustrated in FIG. 8. In this example, a plurality of RM side title ID directories (“001,” “002,” and so on) is present under a “Title” directory, and the stream data 411 and the metadata 412 are stored in each of the RM side title ID directories.

### <4. Procedures in Processing of Information Processing System>

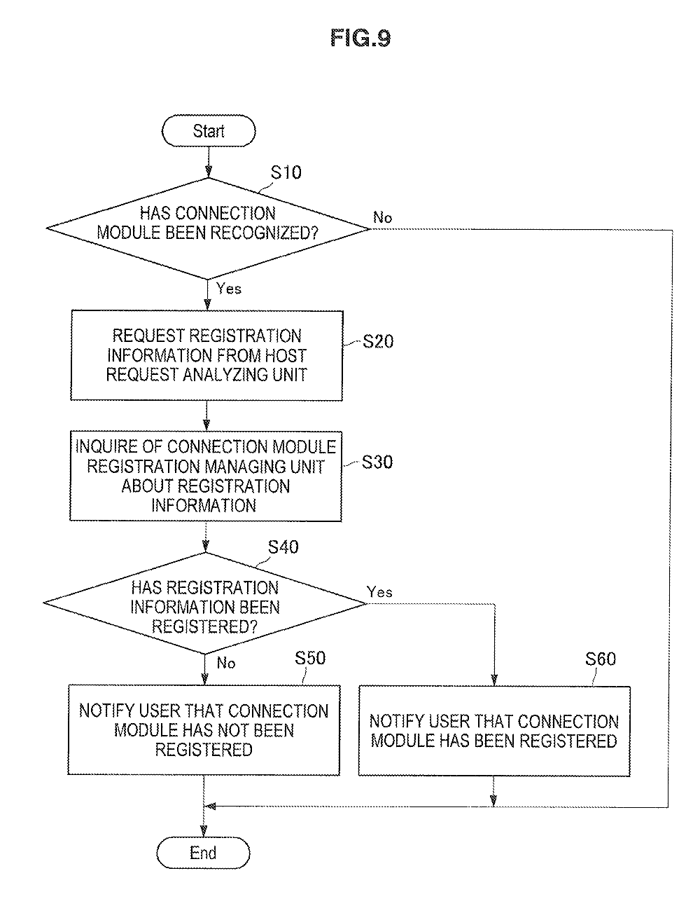

Procedures in processing of the information processing system will now be described with reference to flowcharts illustrated in FIGS. 9 to 13.

### (4-1. Connection Module Recognition Processing)

First, connection module recognition processing will be described with the flowchart illustrated in FIG. 9. Note that it is not necessary for the removable medium 40 to be connected to the connection module 30 when this processing is carried out.

In step S10, the connection module control unit 209 determines whether or not the connection module control unit 209 has recognized the connection module 30. If the connection module control unit 209 determines that the connection module control unit 209 has recognized the connection module 30, the processing proceeds to step S20. If the connection module control unit 209 determines that the connection module control unit 209 has not recognized the connection module 30, the processing is terminated.

In step S20, the connection module control unit 209 requests the host request analyzing unit 311 to acquire registration information. The host request analyzing unit 311 then requests the registration information from the module registration information managing unit 312. The module registration information managing unit 312 outputs the registration information (registration information on the connection module 30) to the host request analyzing unit 311, and the host request analyzing unit 311 outputs the acquired registration information to the connection module control unit 209.

In step S30, the connection module control unit 209 confirms with the connection module registration managing unit 210 whether or not the acquired registration information has already been registered. Note that if the acquired registration information has not been registered, connection module registration processing, which will be described later, will be carried out in response to a request from a user. The connection module registration managing unit 210 determines whether or not the registration information which the connection module control unit 209 has acquired has already been registered in the television receiver 20 and outputs a determination result to the connection module control unit 209.

If the connection module control unit 209 determines, in step S40, that the acquired registration information has already been registered in the television receiver 20, the processing proceeds to step S60. If the connection module control unit 209 determines that the acquired registration information has not been registered in the television receiver 20, the processing proceeds to step S50.

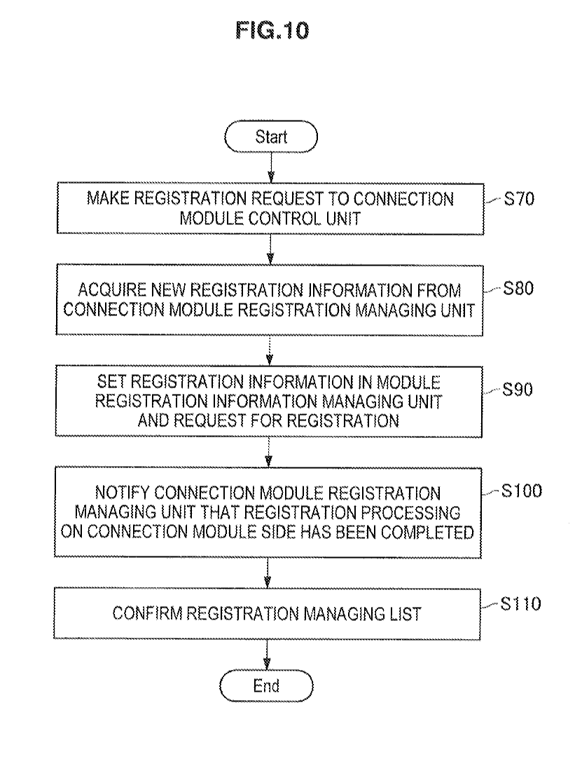

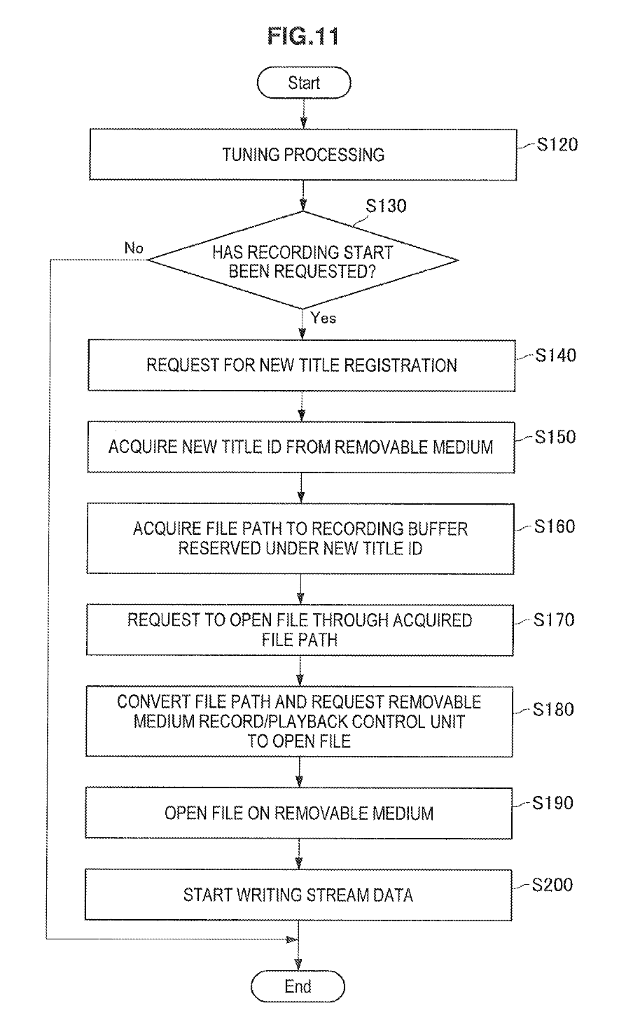

In step S50, the connection module control unit 209 outputs visual information and audio information indicating that the acquired registration information has not been registered through the video and audio output unit 201. Through this, the connection module control unit 209 notifies the user to the effect that the connection module 30 that is connected to the television receiver 20 has not been registered. Thereafter, the television receiver 20 terminates the processing. If the user desires to register the connection module 30, the user inputs request information to that effect into the input device 60. In this case, the television receiver 20 proceeds to the connection module registration processing illustrated in FIG. 10.

Meanwhile, in step S60, the connection module control unit 209 outputs visual information and audio information indicating that the acquired registration information has already been registered through the video and audio output unit 201. Through this, the connection module control unit 209 notifies the user to the effect that the connection module 30 that is connected to the television receiver 20 has already been registered. Thereafter, the television receiver 20 terminates the processing.

### (4-2. Connection Module Registration Processing)

Next, the connection module registration processing will be described with the flowchart illustrated in FIG. 10. Note that the assumption here is that the user has connected the connection module 30 to the television receiver 20 and has made a request for the registration processing using the input device 60.

In step S70, upon receiving a request for connection module registration, the user operation analyzing unit 205 makes a registration request to the connection module control unit 209. The connection module control unit 209 then requests new registration information from the connection module registration managing unit 210.

In step S80, the connection module registration managing unit 210 generates new registration information, which has not been registered in the registration managing list, and outputs the new registration information to the connection module control unit 209.

In step S90, the connection module control unit 209 outputs the new registration information to the host request analyzing unit 311. That is, the connection module control unit 209 makes a registration request to the host request analyzing unit 311. The host request analyzing unit 311 registers the acquired new registration information into the module registration information managing unit 312.

In step S100, the connection module control unit 209 notifies the connection module registration managing unit 210 to the effect that the registration has been completed. In step S110, the connection module registration managing unit 210 adds the new registration information to the registration managing list, to thereby confirm the registration managing list. Thereafter, the television receiver 20 terminates the processing.

### (4-3. Recording Start Processing)

Next, recording start processing will be described with the flowchart illustrated in FIG. 11. In step S120, a user makes a tuning request using the input device 60. Upon receiving the tuning request, the user operation analyzing unit 205 makes a tuning request to the channel control unit 204. The channel control unit 204 then tunes the receiving unit 202 (tuning processing) in accordance with a requested channel. If the receiving unit 202 has already been tuned to a desired channel, the tuning processing is skipped.

In step S130, the user operation analyzing unit 205 determines whether or not there has been a recording start request. If the user operation analyzing unit 205 determines that there has been a recording start request, the processing proceeds to step S140. If the user operation analyzing unit 205 determines that there is no recording start request, the processing is terminated. Note that the assumption in the present embodiment is that the user has made a recording start request using the input device 60 (e.g., remote control, GUI (graphical user interface), and so on). Note that the user may have inputted a channel, recording start and end times in advance (so-called programmed recording function). In this case, the television receiver 20 carries out processing from step S140 and onward at the recording start time.

In step S140, the user operation analyzing unit 205 makes a recording start request to the record/playback control unit 206. The record/playback control unit 206 makes a new title registration request to the database control unit 211 in order to acquire virtual path information (i.e., file path to the stream buffer 112). The new title registration request is notified to the removable medium title managing unit 313 through the connection module control unit 209 and the host request analyzing unit 311.

The removable medium title managing unit 313 searches through the title database 413 on the removable medium 40 through the removable medium control unit 315. Then, the removable medium title managing unit 313 acquires a new RM side title ID. For example, the removable medium title managing unit 313 acquires a new RM side title ID “XXX.” Hereinafter, the processing will be described more specifically with a case where the removable medium title managing unit 313 acquires the new RM side title ID “XXX” as an example.

In step S160, the removable medium title managing unit 313 reserves an information recording buffer (recording buffer) using the RM side title ID “XXX.” To be more specific, the removable medium title managing unit 313 outputs to the file access conversion unit 314 reservation request information that contains the RM side title ID “XXX.” The file access conversion unit 314 secures the information recording buffer in accordance with the reservation request information and outputs a file path to the information recording buffer (i.e., virtual path information) to the removable medium title managing unit 313.

The removable medium title managing unit 313 outputs the virtual path information to the record/playback control unit 206 through the host request analyzing unit 311, the connection module control unit 209, and the database control unit 211.

In step S170, the record/playback control unit 206 requests the connection module 30 to open a stream file using the acquired virtual path information (i.e., the file path). To be more specific, the record/playback control unit 206 outputs virtual file open request information (file open request information) that contains the virtual path information to the file access conversion unit 314 through the file access control unit 208.

Here, the recording buffer that is specified in the virtual file open request information is already reserved under the RM side title ID “XXX.” Thus, in step S180, the file access conversion unit 314 outputs the virtual file open request information to the ring buffer control unit 321. The ring buffer control unit 321 opens the recording buffer that is specified in the virtual file open request information. Meanwhile, the file access conversion unit 314 acquires the file path to “XXX” (file path (/Title/XXX/ . . . ) on the removable medium 40) (actual path information) through the removable medium control unit 315.

The file access conversion unit 314 generates file open request information that contains the acquired actual path information and outputs the file open request information to the removable medium DRM control unit 323 and the removable medium metadata control unit 324. The removable medium DRM control unit 323 generates a stream file at an address that is specified in the actual path information. The stream data 411 is stored in the stream file. Similarly, the removable medium metadata control unit 324 generates a metadata file at an address that is specified in the actual path information. The metadata 412 is stored in the metadata file.

In step S190, the removable medium DRM control unit 323 opens the stream file, and the removable medium metadata control unit 324 opens the metadata file.

In step S200, the record/playback control unit 206 starts recording the stream data into the recording buffer. To be more specific, the receiving unit 202 receives the stream data and outputs the stream data to the decode/output unit 203. The decode/output unit 203 decodes the stream data and outputs the decoded stream data to the record/playback control unit 206. The record/playback control unit 206 then outputs the stream data to the local encryption/decryption control unit 207. The local encryption/decryption control unit 207 locally encrypts the stream data to generate encrypted information and outputs the encrypted information to the file access control unit 208. The file access control unit 208 outputs the encrypted information to the file access conversion unit 314, and the file access conversion unit 314 outputs the encrypted information to the ring buffer control unit 321. The ring buffer control unit 321 records the encrypted information into the recording buffer (recording buffer that is specified in the virtual path information).

Here, the ring buffer control unit 321 annularly manages and controls the recording buffer of a fixed length, and thus the record/playback control unit 206 can sequentially writes the stream data irrespective of a buffer length. The encrypted information that has been written into the recording buffer is then decrypted by the local encryption/decryption control unit 322 (i.e., the local code is decrypted).

The local encryption/decryption control unit 322 decrypts the encrypted information to generate the stream data and outputs the stream data to the removable medium DRM control unit 323 and the removable medium metadata control unit 324. The removable medium DRM control unit 323 converts the stream data in accordance with the DRM standards that are compatible with the removable medium 40 to generate the stream data 411 and records the stream data 411 at an address that is specified in the actual path information.

Meanwhile, the removable medium metadata control unit 324 analyzes the stream data to extract metadata for facilitating a playback control from the stream data. The removable medium metadata control unit 324 converts the metadata in accordance with the DRM standards that are compatible with the removable medium 40 to generate the metadata 412 and records the metadata 412 at an address that is specified in the actual path information. In addition, the removable medium control unit 315 fills in a blank portion that corresponds to the RM side identification information “XXX” in the title database 413. Thereafter, the information processing system 10 terminates the processing.

### (3-4. Playback Start Processing)

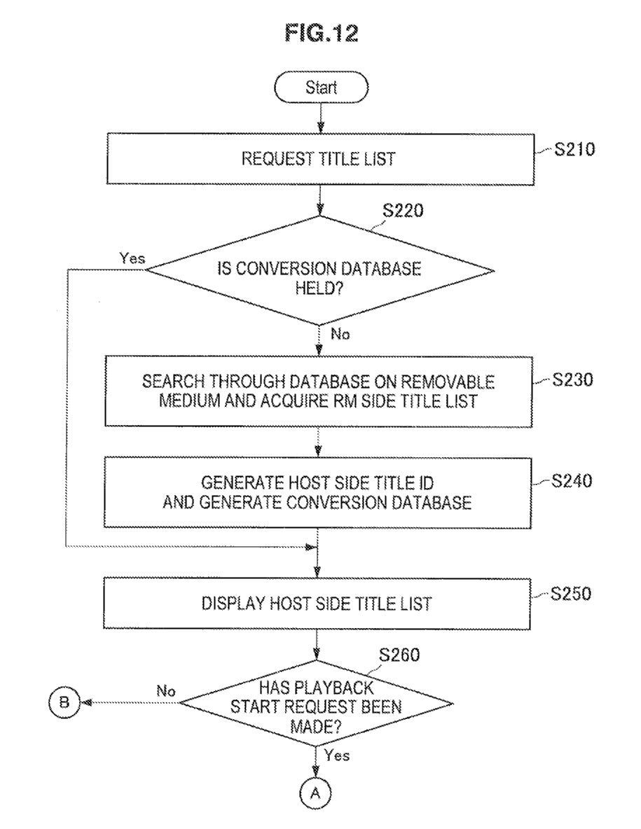

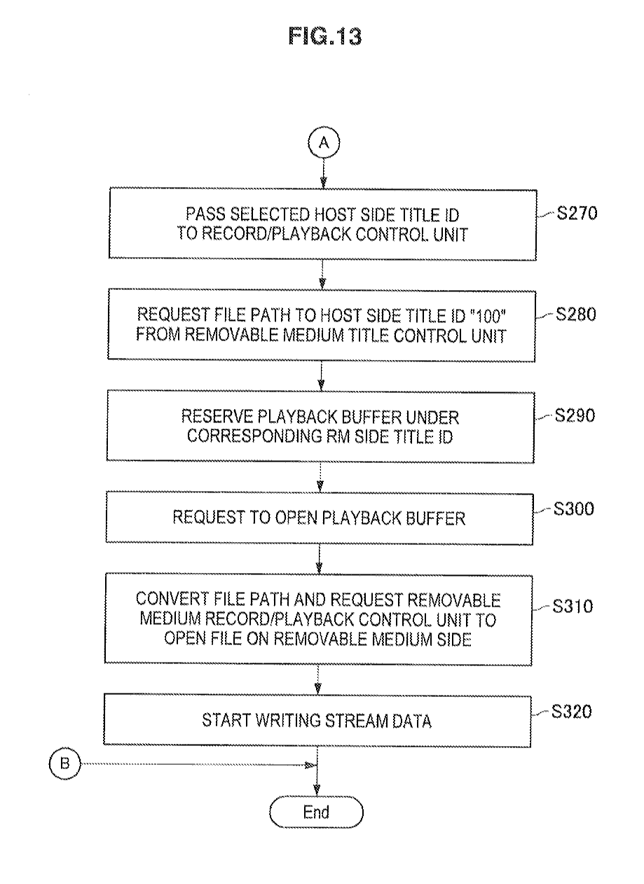

Next, playback start processing will be described with the flowcharts illustrated in FIGS. 12 and 13. Note that, in the present embodiment, a user causes the video and audio output unit 201 to display a host side title list (list of host side identification information) and selects any one host side title from the host side title IDs listed in the host side title list.

That is, in step S210, the user makes a host side title list acquisition request using the input device 60. The host side title list acquisition request is outputted to the removable medium title managing unit 313 through the user operation analyzing unit 205, the database control unit 211, the connection module control unit 209, and the host request analyzing unit 311.

In step S220, the removable medium title managing unit 313 determines whether or not the removable medium title managing unit 313 has already generated (i.e., holds) the conversion database described above. If the removable medium title managing unit 313 determines that the removable medium title managing unit 313 holds the conversion database, the processing proceeds to step S250. If the removable medium title managing unit 313 determines that the removable medium title managing unit 313 does not hold the conversion database, the processing proceeds to step S230. Note that when a title list acquisition request is made the first time after the removable medium 40 is connected to the connection module 30, the removable medium title managing unit 313 does not hold the conversion database. Accordingly, in this case, the removable medium title managing unit 313 proceeds to step S230.

In step S230, the removable medium title managing unit 313 searches through the title database 413 on the removable medium 40, to thereby acquire an RM side title list. Here, the RM side title list is a list of RM side title IDs.

In step S240, the removable medium title managing unit 313 generates a host side title ID for each RM side title ID. Then, the removable medium title managing unit 313 generates a conversion database in which the RM side title IDs and the host side title IDs are associated with each other. Then, the removable medium title managing unit 313 registers the conversion database as a database in the connection module 30. If the television receiver 20 desires, a title list including title names and playback times is also included in the conversion database.

In step S250, the removable medium title managing unit 313 generates a host side title list based on the conversion database and outputs the host side title list to the decode/output unit 203. The decode/output unit 203 then outputs the host side title list to the video and audio output unit 201.

In step S260, the user operation analyzing unit 205 determines whether or not there has been a playback start request. If the user operation analyzing unit 205 determines that there has been a playback start request, the processing proceeds to step S270. If the user operation analyzing unit 205 determines that there is no playback start request, the processing is terminated. Meanwhile, the user selects any one title ID among the host side title IDs listed in the host side title list, to thereby make a playback start request. Hereinafter, this processing will be described more specifically with a case where the user selects a host side title ID “100” as an example.

In step S270, the user operation analyzing unit 205 passes playback start request information indicating that there has been a playback start request to the record/playback control unit 206.

In step S280, the record/playback control unit 206 requests a file path (virtual path information) to a playback buffer (information playback buffer) from the file access conversion unit 314. To be more specific, the record/playback control unit 206 includes information indicating a request for the virtual path information into the playback start request. Then, the record/playback control unit 206 outputs the playback start request to the file access conversion unit 314.

In step S290, the file access conversion unit 314 outputs the playback start request information to the removable medium title managing unit 313. The removable medium title managing unit 313 converts the host side title ID “100” that is included in the playback start request information into an RM side title ID (playback start request identification information) “999” using the conversion database (see FIG. 7). The removable medium title managing unit 313 outputs the acquired RM side title ID “999” to the file access conversion unit 314. The file access conversion unit 314 then secures a playback buffer using the RM side title ID “999” and outputs a file path (virtual path information) to the playback buffer to the file access conversion unit 314. Through this, the playback buffer which the file access conversion unit 314 manages is reserved under the RM side title ID “999.”

In step S300, the file access conversion unit 314 passes the virtual path information to the record/playback control unit 206. The record/playback control unit 206 requests the file access conversion unit 314 to open the playback buffer using the acquired virtual path information. To be more specific, the record/playback control unit 206 outputs virtual file open request information that contains the virtual path information to the file access conversion unit 314 through the file access control unit 208.

Here, the playback buffer that is specified in the virtual file open request information is already reserved under the RM side title ID “999.” Thus, in step S310, the file access conversion unit 314 outputs the virtual file open request information to the ring buffer control unit 321. The ring buffer control unit 321 then opens the playback buffer that is specified in the virtual file open request information. Meanwhile, the file access conversion unit 314 acquires a file path to the RM side title ID “999” (file path (/Title/999/ . . . ) on the removable medium 40) (actual path information) through the removable medium control unit 315.

The file access conversion unit 314 generates file open request information that contains the acquired actual path information and outputs the file open request information to the removable medium DRM control unit 323 and the removable medium metadata control unit 324. The removable medium DRM control unit 323 opens the stream file that is specified in the actual path information, and the removable medium metadata control unit 324 opens the metadata file that is specified in the actual path information.

In step S320, the record/playback control unit 206 starts reading out the stream data. To be more specific, the removable medium DRM control unit 323 acquires the stream data 411 (playback start request content) from the opened stream file and releases the DRM information of the stream data 411. The removable medium DRM control unit 323 then outputs to the local encryption/decryption control unit 322 the stream data of which the DRM information is released. Similarly, the removable medium metadata control unit 324 acquires the metadata 412 from the opened metadata file and releases the DRM information of the metadata 412. The removable medium metadata control unit 324 then outputs to the local encryption/decryption control unit 322 the metadata of which the DRM information is released.

The local encryption/decryption control unit 322 synthesizes the stream data and the metadata to generate synthetic data and locally encrypts the synthetic data to generate encrypted information. Then, the local encryption/decryption control unit 322 outputs the encrypted information to the ring buffer control unit 321. The ring buffer control unit 321 writes the encrypted information into the playback buffer.

The file access conversion unit 314 sequentially reads out the encrypted information from the playback buffer and outputs the encrypted information to the file access control unit 208. The file access control unit 208 then outputs the encrypted information to the local encryption/decryption control unit 207. The local encryption/decryption control unit 207 decrypts the encrypted information to generate the synthetic data and outputs the synthetic data to the record/playback control unit 206. The record/playback control unit 206 then outputs the synthetic data to the video and audio output unit 201. Through this, the synthetic data is played back (displayed). Thereafter, the information processing system 10 terminates the processing.

In the operations described thus far, with the present embodiment, the television receiver 20 accesses the removable medium 40 with a common control method (local encryption and decryption) through the connection module 30, and thus it is not necessary for the control to be modified for each removable medium 40.

Furthermore, the television receiver 20 locally encrypts the stream data to generate the encrypted information. Then, the connection module 30 decrypts the encrypted information to generate the stream data and converts the stream data in accordance with the DRM standards that are compatible with the removable medium 40. Then, the connection module 30 stores the converted stream data 411 into the removable medium 40. Accordingly, the television receiver 20 can be compliant with the media-bind as long as the television receiver 20 is compliant with the device-bind.

Furthermore, any television receiver 20 or 20′ that is already compliant with the device-bind can comply with the removable medium 40 with little influence on the existing systems (hardware and software).

Moreover, even in a case where a new removable medium 40 is provided in the future, the present embodiment makes it possible to take care of the situation only on the connection module 30 side. In addition, separately providing the connection module 30 makes it easier for the user to additionally purchase a function in accordance with the user's needs.

To be more specific, the connection module 30 acquires the encrypted information from the television receiver 20 and decrypts the encrypted information to acquire the stream data (content) 411. Then, the connection module 30 stores the stream data 411 into the removable medium 40. The stream data 411 that is stored in the removable medium 40 can be played back as long as a given medium is compatible with the removable medium 40. Accordingly, the connection module allows the locally encrypted information, that is, the encrypted information to be shared among a plurality of devices.

Furthermore, the connection module 30 allows a given device to play back the stream data 411 as long as the given device is compliant with the device-bind even if the given device is not compatible with the removable medium 40. Examples of such devices include the television receivers 20 and 20′ of the present embodiment. In this way, the television receivers 20 and 20′ can record and play back the stream data 411 irrespective of the presence of the removable medium 40.

Furthermore, the connection module 30 records the encrypted information into the recording buffer if the connection module 30 is provided with the file open request information that contains the virtual path information from the television receiver 20, and thus the encrypted information can be recorded into the recording buffer more reliably.

Furthermore, the connection module 30 acquires the stream data 411 from the removable medium 40 and encrypts the stream data 411 with a local code to generate the encrypted information. Then, the connection module 30 outputs the encrypted information to the television receiver 20. Accordingly, the television receiver 20 can play back the stream data 411 even if the television receiver 20 is not compliant with the media-bind.

Furthermore, the connection module 30 generates the conversion database, and thus the mutual conversion between the RM side title ID and the host side title ID can be carried out based on the conversion database.

Furthermore, the connection module 30 generates the host side title list based on the conversion database and outputs the host side title list to the television receiver 20. Accordingly, the television receiver 20 can display the host side title list, and thus the user can easily select a desired title ID.

Furthermore, the connection module 30 converts the host side title ID into the RM side title ID based on the conversion database if the connection module 30 is provided with the playback start request information that contains the host side title ID from the television receiver 20 and secures the playback buffer using this RM side title ID. Accordingly, the connection module 30 can record the encrypted information into the playback buffer more reliably.

Thus far, preferred embodiments of the present disclosure have been described in detail with reference to the accompanying drawings, but the technical scope of the present disclosure is not limited to the examples described above. It is apparent that a person of ordinary skill in the art can make various variations and modifications without departing from the technical spirit described in the appended claims, and it is understood that such variations and modifications are encompassed within the technical scope of the present disclosure. For example, the internal data structures and the databases described above are not limited to the examples discussed above.

For example, although a television receiver has served as the information processing apparatus in the embodiments described above, the present technique is not limited to such an example. For example, the information processing apparatus may be various types of recorders.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing apparatus, including:

a communication unit configured to acquire encrypted information that is encrypted with a local code from another information processing apparatus; and

a control unit configured to decrypt the encrypted information to generate content and store the content into a removable medium.

(2) The information processing apparatus according to (1),

wherein the removable medium stores removable medium side identification information for identifying the content and the content in association with each other,

wherein the communication unit acquires new removable medium side identification information that is not associated with the content, secures an information recording buffer using the new removable medium side identification information, and notifies the other information processing apparatus of virtual path information that contains a path to the information recording buffer, and

wherein, when file open request information that contains the virtual path information is provided by the other information processing apparatus, the control unit records the encrypted information into the information recording buffer, decrypts the encrypted information that is recorded in the buffer to generate the content, and records the new removable medium side identification information and the content in association with each other into the removable medium.

(3) An information processing apparatus, including:

a control unit configured to acquire content from a removable medium and encrypt the content with a local code to generate encrypted information; and

a communication unit configured to output the encrypted information to another information processing apparatus.

(4) The information processing apparatus according to (3),

wherein the removable medium stores removable medium side identification information for identifying the content and the content in association with each other, and

wherein the communication unit converts the identification information into a format that is compatible with the other information processing apparatus to generate host side identification information, and generates a conversion database in which the removable medium side identification information and the host side identification information are associated with each other.

(5) The information processing apparatus according to (4),

wherein the communication unit outputs a list of the host side identification information to the other information processing apparatus.

(6) The information processing apparatus according to (5),

wherein, when playback start request information that contains any one piece of the host side identification information is provided by the other information processing apparatus, the communication unit acquires playback start request identification information that corresponds to the playback start request information based on the conversion database, secures an information playback buffer using the playback start request identification information, and notifies the other information processing apparatus of virtual path information that contains a path to the information playback buffer, and

wherein, when file open request information that contains the virtual path information is provided by the other information processing apparatus, the control unit acquires playback start request content that corresponds to the playback start request identification information from the removable medium, encrypts the playback start request content with a local code to generate the encrypted information, and records the encrypted information into the information playback buffer.

(7) An information processing method, including:

acquiring encrypted information that is encrypted with a local code from another information processing apparatus; and

decrypting the encrypted information to generate content and storing the content into a removable medium.

(8) An information processing method, including:

acquiring content from a removable medium and encrypting the content with a local code to generate encrypted information; and

outputting the encrypted information to another information processing apparatus.

(9) A program to cause a computer to realize:

a communication function of acquiring encrypted information that is encrypted with a local code from another information processing apparatus; and

a control function of decrypting the encrypted information to generate content and storing the content into a removable medium.

(10) A program to cause a computer to realize:

a control function of acquiring content from a removable medium and encrypting the content with a local code to generate encrypted information; and

a communication function of outputting the encrypted information to another information processing apparatus.

(1). An information processing system, including:

a first information processing apparatus; and

a second information processing apparatus including
a communication unit configured to acquire encrypted information that is encrypted with a local code from the first information processing apparatus, and
a control unit configured to decrypt the encrypted information to generate content and store the content into a removable medium.

(12) An information processing system, including:

a first information processing apparatus; and

a second information processing apparatus including
a control unit configured to acquire content from a removable medium and encrypt the content with a local code to generate encrypted information, and
a communication unit configured to output the encrypted information to the first information processing apparatus.

The present disclosure contains subject matter related to that disclosed in Japanese Priority Patent Application JP 2012-162490 filed in the Japan Patent Office on Jul. 23, 2012, the entire content of which is hereby incorporated by reference.

What is claimed is:

1. An information processing apparatus, comprising:
a communication unit configured to acquire encrypted information that is encrypted with a local code from another information processing apparatus; and
a control unit configured to decrypt the encrypted information to generate content and store the content into a removable medium.

2. The information processing apparatus according to claim 1,
wherein the removable medium stores removable medium side identification information for identifying the content and the content in association with each other,
wherein the communication unit acquires new removable medium side identification information that is not associated with the content, secures an information recording buffer using the new removable medium side identification information, and notifies the other information processing apparatus of virtual path information that contains a path to the information recording buffer, and
wherein, when file open request information that contains the virtual path information is provided by the other information processing apparatus, the control unit records the encrypted information into the information recording buffer, decrypts the encrypted information that is recorded in the buffer to generate the content, and records the new removable medium side identification information and the content in association with each other into the removable medium.

3. An information processing apparatus, comprising:
a control unit configured to acquire content from a removable medium and encrypt the content with a local code to generate encrypted information; and
a communication unit configured to output the encrypted information to another information processing apparatus.

4. The information processing apparatus according to claim 3,
wherein the removable medium stores removable medium side identification information for identifying the content and the content in association with each other, and
wherein the communication unit converts the removable medium side identification information into a format that is compatible with the other information processing apparatus to generate host side identification information, and generates a conversion database in which the removable medium side identification information and the host side identification information are associated with each other.

5. The information processing apparatus according to claim 4,
wherein the communication unit outputs a list of the host side identification information to the other information processing apparatus.

6. The information processing apparatus according to claim 5,
wherein, when playback start request information that contains any one piece of the host side identification information is provided by the other information processing apparatus, the communication unit acquires playback start request identification information that corresponds to the playback start request information based on the conversion database, secures an information playback buffer using the playback start request identification information, and notifies the other information processing apparatus of virtual path information that contains a path to the information playback buffer, and
wherein, when file open request information that contains the virtual path information is provided by the other information processing apparatus, the control unit acquires playback start request content that corresponds to the playback start request identification information from the removable medium, encrypts the playback start request content with a local code to generate the encrypted information, and records the encrypted information into the information playback buffer.

7. An information processing method, comprising:
acquiring encrypted information that is encrypted with a local code from another information processing apparatus; and
decrypting the encrypted information to generate content and storing the content into a removable medium.

8. An information processing method, comprising:
acquiring content from a removable medium and encrypting the content with a local code to generate encrypted information; and
outputting the encrypted information to another information processing apparatus.

9. A program to cause a computer to realize:
a communication function of acquiring encrypted information that is encrypted with a local code from another information processing apparatus; and
a control function of decrypting the encrypted information to generate content and storing the content into a removable medium.

10. A program to cause a computer to realize:
a control function of acquiring content from a removable medium and encrypting the content with a local code to generate encrypted information; and
a communication function of outputting the encrypted information to another information processing apparatus.

11. An information processing system, comprising:
a first information processing apparatus; and
a second information processing apparatus including
a communication unit configured to acquire encrypted information that is encrypted with a local code from the first information processing apparatus, and
a control unit configured to decrypt the encrypted information to generate content and store the content into a removable medium.

12. An information processing system, comprising:
a first information processing apparatus; and
a second information processing apparatus including
a control unit configured to acquire content from a removable medium and encrypt the content with a local code to generate encrypted information, and
a communication unit configured to output the encrypted information to the first information processing apparatus.
